(19) United States
(12) Patent Application Publication
(10) Pub. No.: US 2003/0120683 A1
(43) Pub. Date: Jun. 26, 2003

(54) Architecture for context based adaptable behavior

(75) Inventors: Roderick L. Roma, Germantown, MD (US); Deepak Bhatnager, Burke, VA (US); Daniel Dong Min Shin, Silver Spring, MD (US)

Correspondence Address: FOLEY AND LARDNER, SUITE 500, 3000 K STREET NW, WASHINGTON, DC, 20007, US

(73) Assignee: G.E. INFORMATION SERVICES, INC.

(21) Appl. No.: 10/022,359

(22) Filed: Dec. 20, 2001

(51) Int. Cl. G06F 7/00

(52) U.S. Cl. 707/104.1

(57) ABSTRACT

A system and method for executing an application includes receiving an identification of a first customer, identifying one or more applications accessible to the first customer based on the identification, and receiving a selection of a first application from the one or more applications to execute. One or more rules applicable to the first application are identified, and one or more generic tasks are executed that are stored in a first area accessible to all customers according to the identified one or more rules. In addition, at least one customized task is executed according to the identified one or more rules, the at least one customized task being stored in a second area accessible only to the first customer.

### FIELD OF THE INVENTION

The present invention relates generally to developing software applications, and more particularly to a system and method for developing and maintaining software applications using generic and customized tasks.

### BACKGROUND OF THE INVENTION

Business-to-business applications enable transactions between businesses to be executed electronically. For the service providers creating these applications, it is desirable for the applications to be generic enough to fulfill the needs of many businesses or clients in a variety of industries. Nevertheless, different clients have different business needs and ways of doing things. For example, each client typically has a unique set of data, processes and workflow to accomplish a particular task. Although there is overlap between companies, the differences are often significant enough for the need to develop a separate custom application to suit the client's needs.

As a result of these differences and to serve the business needs of each client, separate installations of the application for each client must be developed, deployed and maintained. Accommodating the separate and custom applications requires extraordinary resources, both short-term and long-term.

In conventional applications, rules setting forth the order of operation of tasks are embedded everywhere in the code base of the application. Each task in the application decides what the next task should be. In addition, code is often not modularized to support the idea of tasks. As a result, modifying the code to support customized logic becomes expensive. Consequently, it often occurs that separate instances of the application must be developed and deployed for each client using the application.

FIG. 1 is a block diagram showing the effect of maintaining separate customized instances of an application for each company. Although the application customized for a company, such as Company A, can reuse all of the components of the generic application, there are now more than one instance of the application to maintain. If the other companies come along having their own company specific business needs, it becomes necessary to deploy and maintain multiple instances of the application including each customized instance as well as the generic application. As a result, the number of instances that must be deployed increase on the order of N as more companies request their own customized application.

Accordingly, it would be desirable to have a more cost-effective way to support the custom business needs of companies, such as for business-to-business applications to conduct electronic transactions.

### SUMMARY OF THE INVENTION

Briefly, a method for executing an application consistent with the present invention includes receiving an identification of a first customer, identifying one or more applications accessible to the first customer based on the identification, and receiving a selection of a first application from the one or more applications to execute. One or more rules applicable to the first application are identified, and one or more generic tasks are executed that are stored in a first area accessible to all customers according to the identified one or more rules. In addition, at least one customized task is executed according to the identified one or more rules, the at least one customized task being stored in a second area accessible only to the first customer.

In another aspect of the present invention, a method for developing an application includes identifying one or more rules and one or more generic tasks corresponding to the identified one or more rules included in a first generic application, receiving a request to modify the first generic application into a first custom application, and generating at least one customized task based upon the received request. At least one of the one or more identified rules is modified to incorporate the at least one customized task into the first custom application, the first custom application including at least one of the one or more generic tasks included in the first generic application.

### BRIEF DESCRIPTION OF THE DRAWINGS

FIG. 1 is a block diagram of a conventional application development and maintenance system.

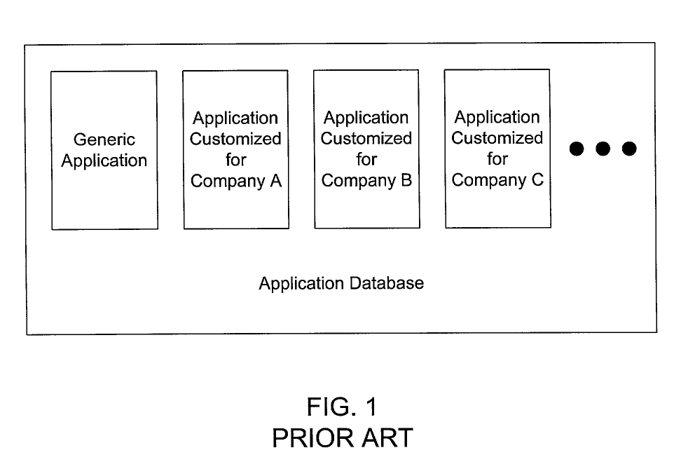

FIG. 2 is a block diagram of a plurality of customers and an application development and maintenance system consistent with the present invention.

FIG. 3 is a more detailed block diagram of the application development and maintenance system of FIG. 2, consistent with the present invention.

FIG. 4 is a flow diagram for developing an application consistent with the present invention.

FIG. 5 is a flow diagram for executing an application maintained on the system of FIG. 3, consistent with the present invention.

### DETAILED DESCRIPTION OF THE PREFERRED EMBODIMENTS

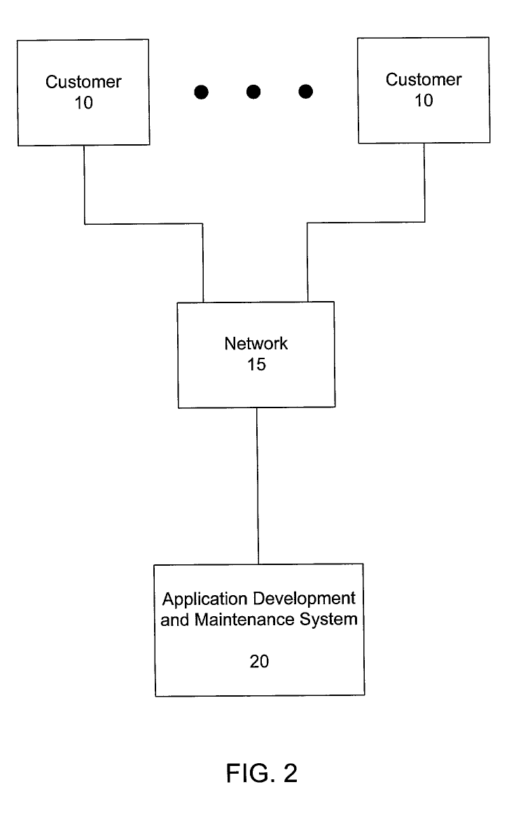

FIG. 2 is a block diagram of a plurality of customers and an application development and maintenance system consistent with the present invention. As shown in FIG. 2, a plurality of customers 10 are each connected to a network 15. The network 15 is also connected to an application development and maintenance system 10.

Each customer 10 may include a workstation having a CPU, a main memory, a ROM, a storage device and a communication interface all coupled together via a bus. The CPU may be implemented as a single microprocessor or as multiple processors for a multi-processing system. The main memory is preferably implemented with a RAM and a smaller-sized cache. The ROM is a non-volatile storage, and may be implemented, for example, as an EPROM or NVRAM. The storage device can be a hard disk drive or any other type of non-volatile, writable storage.

A communication interface provides a two-way data communication coupling via a network link to the network 15. For example, if the communication interface is an integrated services digital network (ISDN) card or a modem, the communication interface provides a data communication connection to the corresponding type of telephone line. If the communication interface is a local area network (LAN) card, the communication interface provides a data communication connection to a compatible LAN. Wireless links are also possible. In any such implementation, the communication interface sends and receives electrical, electromagnetic or optical signals, which carry digital data streams representing different types of information, to and from the network 15. The network 15 may be implemented, for example, as a LAN or as a public network, such as the Internet.

The customer 10 can send messages and receive data, including program code, through the network 15. If the network 150 is implemented as the Internet, the system 20 can transmit a requested code for an application program through the Internet, an ISP, the local network and the communication interface. The received code can be executed by the CPU in the workstation of the customer 10 as it is received, stored in the storage device, or stored in some other non-volatile storage for later execution. In this manner, the customer 10 may obtain application code in the form of a carrier wave.

The system 20 may be implemented in substantially the same manner as the customer 10. In particular, the system 20 may implemented as a server having a CPU, a main memory, a ROM, a storage device and a communication interface all coupled together via a bus. The system 20 may also include a communication interface, which provides a two-way data communication coupling the system 20 to the network 15 via a network link. Like the customer 10, the system 20 can send messages and receive data, including program code, through the network 15.

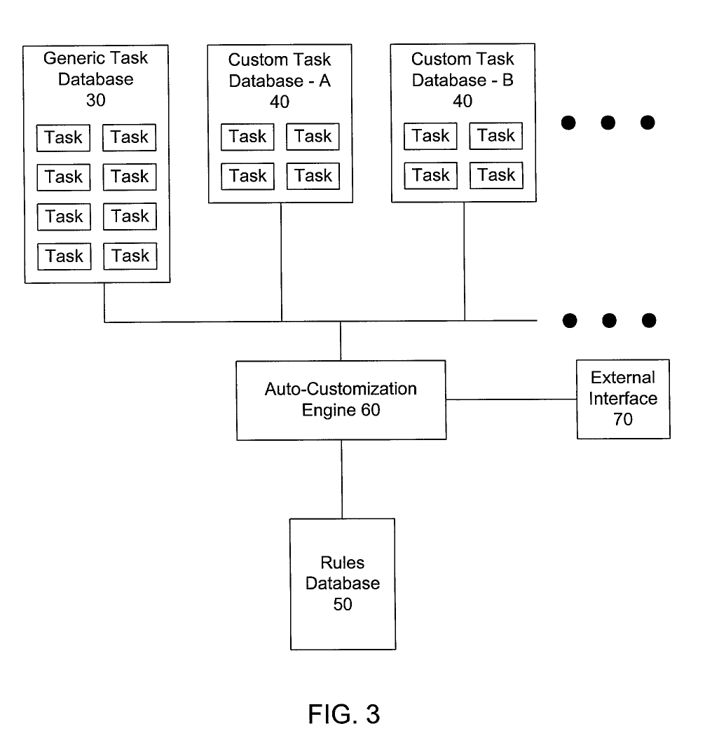

FIG. 3 is a block diagram of an application development and maintenance system 20 consistent with the present invention. As shown in FIG. 3, the system 20 includes a generic task database 30, a plurality of custom task databases 40, a rules database 50, an auto-customization engine 60, and an external interface 70. The external interface 70 is preferably implemented as a communication link that connects the rest of the system 20 to the network 15, as well as the customers 10.

The external interface 70 is coupled to the auto-customization engine 60. The auto-customization engine 60 is designed to coordinate the development, maintenance and execution of applications by customers 10. The auto-customization engine 60 may be implemented in hardware, in software or in a combination thereof. For example, the auto-customization engine 60 may include a processing device, such as a CPU, and a storage device accessed by the processing device to execute the functionality for developing, maintaining and executing applications. The functionality may be implemented as firmware, such as in a ROM, or as software stored in a non-volatile storage, such as a hard disk drive.

The generic task database 30, the custom task databases 40 and the rules database 50 are each coupled to and accessible by the auto-customization engine 60. Each of the databases may be stored in a non-volatile storage, such as a ROM or a hard disk drive. The non-volatile storage may be implemented as a single storage device or may be a plurality of storage devices located in a single location or distributed across multiple locations. The storage of the databases may be implemented using, for example, SQL or any of a variety of different database applications of Oracle Corp.

In the system 20, an application can be viewed as a set of tasks and rules. A task implements a modularized set of actions which provide functionality to the application. For example, for e-commerce applications, a task may be implemented to effect some type of business logic. Rules govern which tasks are to be performed, the sequence in which the tasks are performed, and what data is used in performing the tasks. The rules may also provide any other information required by a task to execute. The rules are preferably based off of contextual information, such as the user, the company, the industry, etc. The rules and tasks are preferably implemented with an object-oriented programming language, such as Java or C++.

The rules are stored in a central, easily modifiable location, i.e., the rules database 50. The tasks are divided into generic and custom tasks, which are stored in the generic task database 30 and the custom task databases 40, respectively. The generic tasks stored in the generic task database 30 are accessible to all customers 10. The custom tasks are developed according to specific application requirements or functionality established by the customer 10. The custom tasks are then stored in a custom task database 40 that is preferably accessible only to that customer 10. At the request of the customer 10, the custom tasks stored in the respective custom task database 40 may be made accessible to one or more other customers 10 identified by the customer 10 corresponding to the custom task database 40.

For a generic application, the application is executed using one or more rules from the rules database 50 and solely generic tasks stored in the generic task database 30. For example, there may be a generic application for generating request for quotes (RFQs), which includes a generic task for creating the details of the RFQ, a generic task for identifying suppliers, and a generic task for submitting the RFQ. The generic application for generating RFQs would have a corresponding rule identifying which generic tasks are part of the application, the order in which the tasks are performed, and what data is used to perform the tasks.

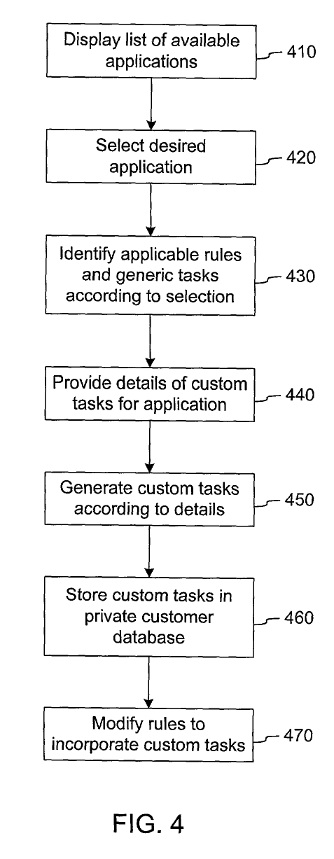

For custom applications, the applications incorporate one or more custom tasks into the generic application. FIG. 4 is a flow diagram for developing a custom application consistent with the present invention. As shown in FIG. 4, a customer 10 first accesses the system 20 via the network 15 and has a list of available applications displayed (step 410). The list of available applications includes all of the generic applications in the system 20, as well as any custom applications previously created by the customer 10 and any other custom application made available by other customers 10. The listed applications are identified by the auto-customization engine 60 based on the identity of the customer 10. The interface between the customer 10 and the system 20 allows the customer 10 to see the display of applications and other relevant information, as well as to enter information. The interface may be implemented in a display language, such as HTML, or with a client server application language, such as visual basic or Java.

Based on the displayed list of applications, the customer 10 can select a desired application (step 420). For example, the customer may select the generic application for creating an RFQ. The selection may be effected through a keyboard input or through the click of a pointing device, such as a mouse. The customer 10 may select the desired application to create a new customized application or to execute the selected application. The process for executing a selecting application is described below.

In the case of creating a customized application, the applicable rules and tasks are identified from the generic task database 30 and the rules database 50 according to the selected application (step 430). The applicable rules and tasks are identified by the auto-customization engine. If the customer 10 is editing a customized application, the identified tasks may include custom tasks stored in the custom task database 40.

To customize the application, the customer 10 provides details of additional functionality to include in the custom application (step 440). The details preferably include information about what additional tasks need to be included in the generic application or a modification to an existing custom application. For example, if the generic application is to create an RFQ, the customer 10 may want to have an additional task in the application that requires supervisory approval of the RFQ before submission if the amount of the RFQ exceeds a predetermine amount, such as $5,000. Alternatively, the customer 10 may want to customize one of the generic tasks included in the generic application. For example, the customer 10 may want to having additional information included in the RFQ than is provided in the generic task for the generation of the RFQ.

The following description provides a generalized explanation of how a generic (or custom application) is modified into a custom application according to the details provided by the customer 10. Assume the application to be customized has tasks A, B, C and D, and a corresponding rule identifying the order of execution of those tasks, as well as what data is needed for each task. Based on the details provided by the customer 10, the application may be modified to add a new task E. The details also indicate where the new task should be added in the sequence of execution. The resulting customized application may then be, in order of execution, A, B, E, C, D. Instead of adding a new task, the details may define how an existing task should be modified, such as task C becoming C′.

After providing the details, the custom tasks are generated according to the details (step 450). The custom tasks are preferably implemented with an object-oriented programming language, such as Java or C++, although other programming languages may be used. The custom tasks are created using standard programming techniques as are known in the art. The custom tasks are designed in view of the other tasks of the application and the data and data types used by the other tasks.

The generated custom tasks are stored in the custom task database 40 corresponding to the customer 10 for whom the custom tasks were generated (step 460). As discussed above, each custom task database 40 preferably stores the custom tasks of a corresponding one of the customers 10, such that the custom task database 40 and the custom tasks stored therein are only accessible to the corresponding customer 10. Having such a limitation on the access to the custom task databases 40 allows them to be stored in a common location, but with security measures limiting the access to each one. In addition, the custom applications can be executed from a common location and by a common execution engine, i.e., the auto-customization engine 60. The limited access to the custom task databases 40 can be selectively expanded by the customer 10 to allow access by one or more other customers 10.

In addition to creating the custom tasks for the custom application, the rules for the custom application are modified (step 470). When a custom task is added, the rules of the custom application are modified to identify the custom task as being part of the custom application and to incorporate the added custom task into the sequence of execution. The rules are also modified to identify what data is used for the added custom task. The modified rules are stored in the rules database 50.

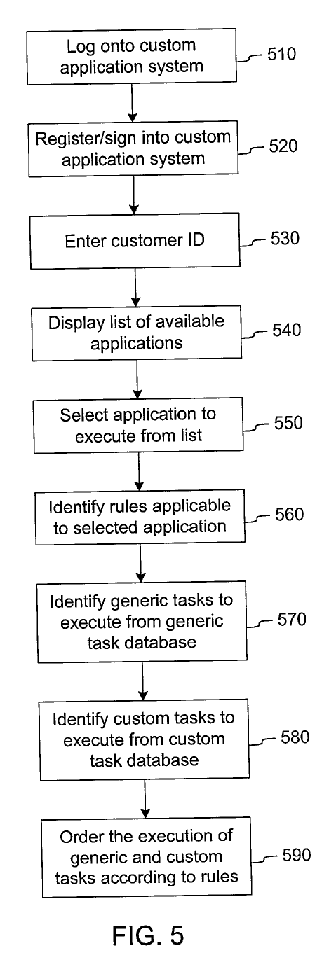

FIG. 5 is a flow diagram for executing an application maintained on the system of FIG. 3, consistent with the present invention. As shown in FIG. 5, a user logs onto the system 20 (step 510). The user is associated with one of the customers 10. The user accesses the system 20 via the network 15. To log onto the system 20, the user may, for example, access the system 20 through the Internet at a web site for the system 20. Other forms of access to the system 20 may also be used as is known in the art.

After logging onto the system 20, the user registers or signs into the system 20 (step 520). When the user first logs onto the system 20, the user registers with the system by providing information identifying the user, identifying the customer 10 to which the user is associated, any payment information, and any other relevant information. The user also provides a username and password to be used in future accesses of the system 20. For subsequent accesses to the system 20, the user signs in by providing the username and password.

The user also enters a customer identifier (ID) (step 530). The customer ID can be generated by the system 20 when the customer 10 registers with the system 20. Alternatively, the user can create their own customer ID when registering. The customer ID establishes a connection between the user to the associated customer 10. The same customer ID is preferably used for all other users associated with a particular customer 10. Alternatively, the customer ID may be recognized automatically based on the username and password provided by the user, thereby obviating the step of entering the customer ID.

Based on the entered customer ID, the system 20 displays a list of available applications for the user (step 540). The list includes the generic applications available to all users, as well as the custom applications for the customer 10 in accordance with the customer ID. To generate the list, the auto-customization engine 60 refers to the customer ID and uses it to identify the custom applications for the associated customer 10. The auto-customization engine 60 preferably includes a table listing the custom applications for each customer 10.

The user selects which application to execute from the displayed list of available applications (step 550). The user may make the selection using a keyboard input or a click of a pointing device, such as a mouse. In response to the selection, the rule or rules applicable to the selected application are identified (step 560). The auto-customization engine 60 identifies the applicable rule or rules from the rules database 60 for the selected application. The auto-customization engine 60 preferably maintains a table identifying which rule or rules are applicable to each application.

The generic tasks for the application are also identified (step 570). As with the rules, the auto-customization engine 60 identifies the applicable generic tasks from the generic task database 30 for the selected application. The same table coupling the rules to applications may also identify which generic tasks are applicable to the application. In addition to the generic tasks, the custom tasks applicable to the selected application are identified (step 580). The auto-customization engine 60 identifies the applicable custom tasks from the custom task database 40 for the selected application. As with the rules and generic tasks, the auto-customization engine 60 preferably maintains a table identifying which custom tasks correspond to each application.

With the rules and applicable tasks identified, the application can be executed in accordance with the rules (step 590). The auto-customization engine 60 refers to the rules to determine the order in which the applicable tasks are to be executed. The auto-customization engine 60 also refers to the rules to determine what data needs to be entered and received during the execution of each task. During the execution of the task, the auto-customization engine 60 may provide prompts to the user to provide any necessary information via the external interface 70.

The foregoing description of a preferred embodiment of the invention has been presented for purposes of illustration and description. It is not intended to be exhaustive or to limit the invention to the precise form disclosed, and modifications and variations are possible in light in the above teachings or may be acquired from practice of the invention. The embodiment was chosen and described to explain the principles of the invention and as a practical application to enable one skilled in the art to utilize the invention in various embodiments and with various modifications suited to the particular use contemplated. It is intended that the scope of the invention be defined by the claims appended hereto and their equivalents.

What is claimed is:

1. A method for executing an application, comprising:
receiving an identification of a first customer;
identifying one or more applications accessible to the first customer based on the identification;
receiving a selection of a first application from the one or more applications to execute;
identifying one or more rules applicable to the first application;
executing one or more generic tasks stored in a first area accessible to all customers according to the identified one or more rules; and
executing at least one customized task according to the identified one or more rules, the at least one customized task being stored in a second area accessible only to the first customer.

2. A method according to claim 1, further comprising:
receiving an identification of a second customer, different from the first customer;
identifying one or more applications accessible to the second customer based on the identification;
receiving a selection of a second application from the one or more applications accessible to the second customer to execute;
identifying one or more rules applicable to the second application;
executing one or more generic tasks stored in the first area accessible to all customers according to the identified one or more rules applicable to the second application; and
executing at least one customized task according to the identified one or more rules applicable to the second application, the at least one customized task being stored in a third area accessible only to the second customer.

3. A method according to claim 2, wherein at least one of the generic tasks executed for the first application is executed for the second application.

4. A method according to claim 2, wherein at least one of the rules applicable to the first application is applicable to the second application.

5. A method for developing an application, comprising:
identifying one or more rules and one or more generic tasks corresponding to the identified one or more rules included in a first generic application;
receiving a request to modify the first generic application into a first custom application;
generating at least one customized task based upon the received request; and
modifying at least one of the one or more identified rules to incorporate the at least one customized task into the first custom application, the first custom application including at least one of the one or more generic tasks included in the first generic application.

6. A method according to claim 5, wherein the request includes details about tasks to include in the first custom application, and
wherein the at least one customized task is generated according to the details.

7. A method according to claim 5, wherein the generating the at least one customized task includes modifying at least one of the one or more generic tasks to generate the at least one customized task.

8. A method according to claim 5, wherein the at least one customized task is a new task different from the identified one or more generic tasks.

9. A method according to claim 5, further comprising receiving an identification of a first customer.

10. A method according to claim 9, further comprising storing the at least on customized task of the first custom application in a location in memory that is only accessible to the first customer.

11. A method according to claim 10, further comprising:
identifying one or more rules and one or more generic tasks corresponding to the identified one or more rules included in a second generic application;
receiving a request to modify the second generic application into a second custom application;
generating at least one customized task based upon the received request to modify the second generic application into the second custom application; and
modifying at least one of the one or more identified rules of the second generic application to incorporate the at least one customized task into the second custom application, the second custom application including at least one of the one or more generic tasks included in the second generic application.

12. A method according to claim 11, further comprising receiving an identification of a second customer, different from the first customer.

13. A method according to claim 12, further comprising storing the at least on customized task of the second custom application in a location in memory that is only accessible to the second customer.

14. A method according to claim 13, wherein the first and second generic applications are the same.

15. A method according to claim 13, wherein the first and second generic application are different.

16. A computer system for executing an application, comprising:
a rules database which stores a plurality of rules, each rule designed to identify one or more tasks to execute and the sequence in which the tasks are performed;
a generic task database which stores generic tasks that are accessible to all customers, each generic task designed to provide a function applicable to at least one application;
at least one custom task database, each custom task database storing custom tasks that are accessible to only a respective customer, each custom task designed to provide a function applicable to at least one custom application;
an external interface which receives an identification of a first customer; and
an auto-customization engine which identifies one or more applications accessible to the first customer based on the identification received by the external interface, the external interface receiving a selection to execute a first application from the identified one or more applications;
wherein the auto-customization engine identifies one or more rules in the rules database applicable to the first application, executes one or more generic tasks stored in the generic task database according to the identified one or more rules, and executes at least one customized task stored in a first custom task database according to the identified one or more rules, the at least one customized task stored in the first custom task database being accessible only to the first customer.

17. A computer system according to claim 16, wherein the external interface receives an identification of a second customer, different from the first customer,
wherein the auto-customization engine identifies one or more applications accessible to the second customer based on the identification of the second customer, the external interface receiving a selection to execute a second application from the one or more applications accessible to the second customer, and
wherein the auto-customization engine identifies one or more rules applicable to the second application, executes one or more generic tasks stored in the generic task database according to the identified one or more rules applicable to the second application, and executes at least one customized task stored in a second custom task database according to the identified one or more rules applicable to the second application, the at least one customized task stored in the second custom task database being accessible only to the second customer.

18. A computer system according to claim 17, wherein at least one of the generic tasks executed for the first application is executed for the second application.

19. A computer system according to claim 17, wherein at least one of the rules applicable to the first application is applicable to the second application.

20. A computer system for developing an application, comprising:
a rules database which stores a plurality of rules, each rule designed to identify one or more tasks to execute and the sequence in which the tasks are performed;
a generic task database which stores generic tasks that are accessible to all customers, each generic task designed to provide a function applicable to at least one application;
at least one custom task database, each custom task database storing custom tasks that are accessible to only a respective customer, each custom task designed to provide a function applicable to at least one custom application;
an auto-customization engine which identifies one or more rules from the rules database and one or more generic tasks corresponding to the identified one or more rules from the generic task database included in a first generic application; and
an external interface which receives a request to modify the first generic application into a first custom application,
wherein the auto-customization engine generates at least one customized task based upon the received request, stores the at least one customized task in a first custom task database and modifies at least one of the one or more identified rules to incorporate the at least one customized task into the first custom application, the first custom application including at least one of the one or more generic tasks included in the first generic application.

21. A computer system according to claim 20, wherein the request includes details about tasks to include in the first custom application, and
wherein the at least one customized task is generated according to the details.

22. A computer system according to claim 20, wherein the auto-customization engine modifies at least one of the one or more generic tasks to generate the at least one customized task.

23. A computer system according to claim 20, wherein the at least one customized task is a new task different from the identified one or more generic tasks.

24. A computer system according to claim 20, wherein the external interface receives an identification of a first customer.

25. A computer system according to claim 24, wherein the first custom task database is only accessible to the first customer.

26. A computer system according to claim 10, wherein the auto-customization engine identifies one or more rules from the rules database and one or more generic tasks corresponding to the identified one or more rules from the generic task database included in a second generic application,
wherein the external interface receives a request to modify the second generic application into a second custom application, and
wherein the auto-customization engine generates at least one customized task based upon the received request to modify the second generic application into the second custom application, stores the at least one customized task in a second custom task database, and modifies at least one of the one or more identified rules of the second generic application to incorporate the at least one customized task into the second custom application, the second custom application including at least one of the one or more generic tasks included in the second generic application.

27. A computer system according to claim 11, wherein the external interface receives an identification of a second customer, different from the first customer.

28. A computer system according to claim 12, wherein the second custom task database is only accessible to the second customer.

29. A computer system according to claim 13, wherein the first and second generic applications are the same.

30. A computer system according to claim 13, wherein the first and second generic application are different.

31. A computer readable medium operable on a computer system for executing an application, the computer readable medium configured to:
receive an identification of a first customer;
identify one or more applications accessible to the first customer based on the identification;
receive a selection of a first application from the one or more applications to execute;
identify one or more rules applicable to the first application;
execute one or more generic tasks stored in a first area accessible to all customers according to the identified one or more rules; and
execute at least one customized task according to the identified one or more rules, the at least one customized task being stored in a second area accessible only to the first customer.

32. A computer readable medium according to claim 1, further configured to:
receive an identification of a second customer, different from the first customer;
identify one or more applications accessible to the second customer based on the identification;
receive a selection of a second application from the one or more applications accessible to the second customer to execute;
identify one or more rules applicable to the second application;
execute one or more generic tasks stored in the first area accessible to all customers according to the identified one or more rules applicable to the second application; and
execute at least one customized task according to the identified one or more rules applicable to the second application, the at least one customized task being stored in a third area accessible only to the second customer.

33. A computer readable medium according to claim 2, wherein at least one of the generic tasks executed for the first application is executed for the second application.

34. A computer readable medium according to claim 2, wherein at least one of the rules applicable t o the first application is applicable to the second application.

35. A computer readable medium operable on a computer system for developing an application, the computer readable medium configured to:
identify one or more rules and one or more generic tasks corresponding to the identified one or more rules included in a first generic application;
receive a request to modify the first generic application into a first custom application;
generate at least one customized task based upon the received request; and
modify at least one of the one or more identified rules to incorporate the at least one customized task into the first custom application, the first custom application including at least one of the one or more generic tasks included in the first generic application.

36. A computer readable medium according to claim 35, wherein the request includes details about tasks to include in the first custom application, and
wherein the at least one customized task is generated according to the details.

37. A computer readable medium according to claim 35, further configured to modify at least one of the one or more generic tasks to generate the at least one customized task.

38. A computer readable medium according to claim 35, wherein the at least one customized task is a new task different from the identified one or more generic tasks.

39. A computer readable medium according to claim 35, further configured to receive an identification of a first customer.

40. A computer readable medium according to claim 39, further configured to store the at least on customized task of the first custom application in a location in memory that is only accessible to the first customer.

41. A computer readable medium according to claim 40, further configured to:
identify one or more rules and one or more generic tasks corresponding to the identified one or more rules included in a second generic application;
receive a request to modify the second generic application into a second custom application;
generate at least one customized task based upon the received request to modify the second generic application into the second custom application; and
modify at least one of the one or more identified rules of the second generic application to incorporate the at least one customized task into the second custom application, the second custom application including at least one of the one or more generic tasks included in the second generic application.

42. A computer readable medium according to claim 41, further configured to receive an identification of a second customer, different from the first customer.

43. A computer readable medium according to claim 42, further configured to store the at least on customized task of the second custom application in a location in memory that is only accessible to the second customer.

44. A computer readable medium according to claim 43, wherein the first and second generic applications are the same.

45. A computer readable medium according to claim 43, wherein the first and second generic application are different.
